(19) United States
(12) Patent Application Publication
(10) Pub. No.: US 2006/0170346 A1
(43) Pub. Date: Aug. 3, 2006

(54) PLASMA DISPLAY PANEL AND METHOD OF MANUFACTURING THE SAME

(75) Inventor: Myeongsoo CHANG, Uiwang-si (KR)

Correspondence Address: FISH & RICHARDSON P.C., P.O. BOX 1022, MINNEAPOLIS, MN, 55440-1022, US

(73) Assignee: LG ELECTRONICS INC., Youngdungpo-gu, Seoul (KR)

(21) Appl. No.: 11/275,788

(22) Filed: Jan. 30, 2006

(30) Foreign Application Priority Data
Feb. 1, 2005 (KR) 1020050009264

(51) Int. Cl. H01J 17/49

(52) U.S. Cl. 313/582

(57) ABSTRACT

A plasma display panel (PDP) and a method of manufacturing the same are provided. The PDP comprises a front panel in which bus electrodes comprising a black material are formed on transparent electrodes and a rear panel attached to the front panel to be separated from each other by a predetermined distance.

This nonprovisional application claims priority under 35 U.S.C. § 119(a) on Patent Application No. 10-2005-0009264 filed in Republic of Korea on Feb. 1, 2005, the entire contents of which are hereby incorporated by reference.

### BACKGROUND OF THE INVENTION

1. Field of the Invention

The present invention relates to a plasma display apparatus, and more particularly, to a plasma display panel (PDP) and a method of manufacturing the same.

2. Description of the Background Art

In a plasma display panel (PDP), a main discharge gas such as Ne, He, and Ne+He and an inert gas comprising a small amount of xenon are filled in a discharge space between a front panel and a rear panel. When discharge is generated by a high frequency voltage, the inert gas in the discharge space generates vacuum ultraviolet (UV) rays and the vacuum UV rays emit light from a phosphor to realize an image.

FIG. 1 illustrates the structure of a common PDP.

As illustrated in FIG. 1, according to the PDP, a front panel 100 obtained by arranging a plurality of pairs of sustain electrodes formed of scan electrodes 102 and sustain electrodes 103 that make pairs and a rear panel 110 obtained by arranging a plurality of address electrodes 113 to intersect the plurality of pairs of sustain electrodes are combined with each other to run parallel to each other by a uniform distance.

In the front panel 100, the scan electrode 102 and the sustain electrode 103 for discharging each other in one discharge cell to sustain emission of the cell are formed on a front glass 101. The scan electrode 102 and the sustain electrode 103 comprise transparent electrodes 102a and 103a made of a transparent material and bus electrodes 102b and 103b made of a metal material such as Ag. The metal material such as Ag of which the bus electrodes are made does not transmit light generated by discharge but reflects external light to deteriorate contrast. In order to solve the problem, a black layer 104 for improving contrast is formed between the transparent electrodes 102a and 103a and the bus electrodes 102b and 103b. The scan electrodes 102 and the sustain electrodes 103 are covered with an upper dielectric layer 105 for restricting discharge current and for insulating electrode pairs from each other. A protective layer 106 on which magnesium oxide (MgO) is deposited is formed on the entire surface of the upper dielectric layer 105 in order to facilitate discharge.

In the rear panel 110, the address electrodes 113 are formed on a rear glass 111 so that data can be written by writing discharge generated between the scan electrode 102 and the address electrodes 113. Also, the address electrodes 113 are covered with a lower dielectric layer 115 so that discharge current is restricted. Stripe type barrier ribs 112 for forming a plurality of discharge cells are arranged on the lower dielectric layer 115 to run parallel to each other. Also, R, G, and B phosphors 114 that emit visible rays for displaying an image during discharge are filled between the lower dielectric layer 115 and the barrier ribs 112.

A method of manufacturing the front panel of the PDP having the above structure will be described with reference to FIG. 2.

FIG. 2 sequentially illustrates processes of manufacturing the front panel of a conventional PDP.

As illustrated in FIG. 2, first, in the step (a), the transparent electrode 102a of indium tin oxide (ITO) made of indium oxide and tin oxide is formed on the front glass 101.

Then, in the step (b), black paste for forming the black layer 104 is printed onto the front glass 101 where the transparent electrode is formed and is dried. In the step (c), a photo mask M provided with a predetermined pattern is put on the dried black paste and is irradiated with UV rays to be dried.

In the step (d), in order to form the bus electrode 102b on the black layer 104, the black layer 104 that went through a photolithography process is coated with Ag paste and the Ag paste is printed onto the black layer 104 to be dried

Then, in the step (e), the photo mask M provided with the predetermined pattern is put on the Ag paste with which the black layer 104 is coated to perform a photolithography process. After the photolithography process, in the step (f), a part that is not hardened is formed and is annealed by an annealing furnace (not shown) to form the bus electrode 102b.

Then, in the step (g), the dielectric layer 105 is formed on the front glass where the scan electrode and the sustain electrode are formed.

Finally, in the step (h), the protective layer 106 made of MgO is formed on the surface of the dielectric layer 105 to complete the front panel of the PDP.

In the processes of manufacturing the front panel of the PDP, printing, drying and photolithography processes are repeated so that processing time increases to deteriorate production yield and to increase manufacturing cost. Also, an align error is generated between the black layer 104 formed on the transparent electrode and the bus electrode 102b.

### SUMMARY OF THE INVENTION

Accordingly, an object of the present invention is to solve at least the problems and disadvantages of the background art.

It is an object of the present invention to provide a plasma display panel (PDP) capable of reducing manufacturing cost.

It is another object of the present invention to provide a method of manufacturing a PDP capable of reducing the number of processes of manufacturing the PDP to improve production yield.

A PDP according to a first embodiment of the present invention comprises a front panel in which bus electrodes comprising a black material are formed on transparent electrodes and a rear panel attached to the front panel to be separated from each other by a predetermined distance.

A PDP according to a second embodiment of the present invention comprises a front panel in which bus electrodes comprising a black material are formed on a substrate and a rear panel attached to the front panel to be separated from each other by a predetermined distance.

A method of manufacturing a plasma display panel according to the present invention comprises the steps of forming a transparent electrode on glass, applying bus electrode paste comprising a black material and Ag onto the transparent electrode, performing photolithography on the bus electrode paste to form a pattern.

According to the present invention, it is possible to prevent an align error from being generated between the black layer and the bus electrode layer of the PDP.

According to the present invention, it is possible to reduce the number of processes of manufacturing the PDP to improve production yield and to reduce manufacturing cost.

### BRIEF DESCRIPTION OF THE DRAWINGS

The present invention will be described in detail with reference to the following drawings in which like numerals refer to like elements.

FIG. 1 illustrates the structure of a common plasma display panel (PDP).

FIG. 2 sequentially illustrates processes of manufacturing a front panel of a conventional PDP.

FIG. 3 illustrates the structure of a PDP according to a first embodiment of the present invention.

FIG. 4 illustrates the structure of a bus electrode of a PDP according to the present invention.

FIG. 5 sequentially illustrates processes of manufacturing the PDP according to the first embodiment of the present invention.

FIG. 6 illustrates the structure of a PDP according to a second embodiment of the present invention.

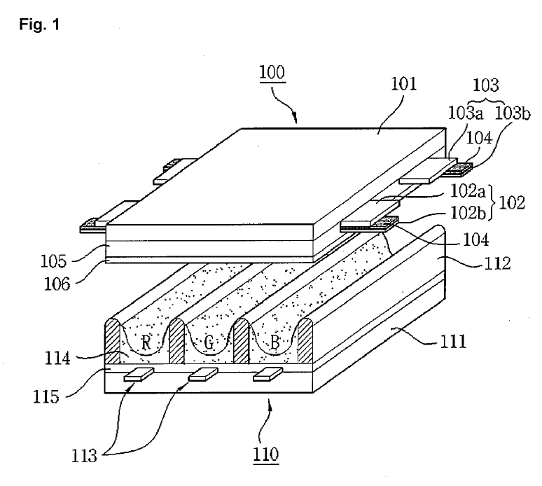

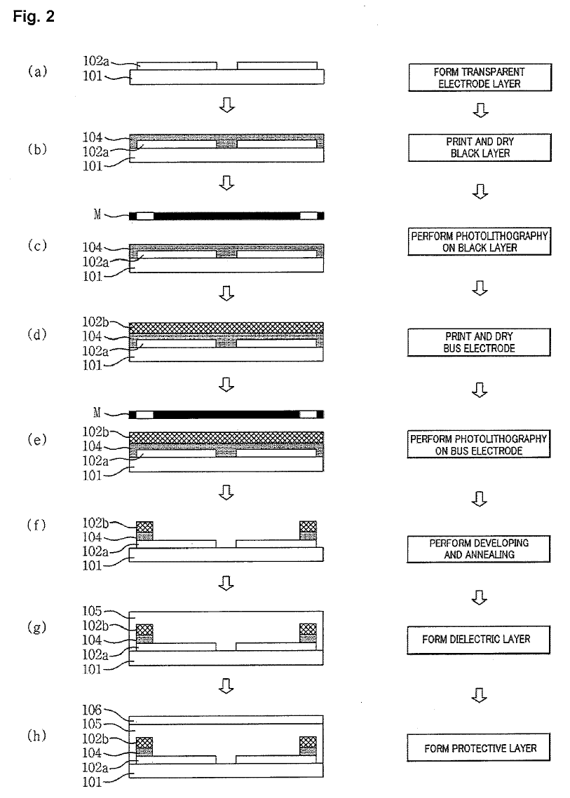

### DETAILED DESCRIPTION OF PREFERRED EMBODIMENTS

Preferred embodiments of the present invention will be described in a more detailed manner with reference to the drawings.

A plasma display panel (PDP) according to a first embodiment of the present invention comprises a front panel in which bus electrodes comprising a black material are formed on transparent electrodes and a rear panel attached to the front panel to be separated from each other by a predetermined distance.

The bus electrode comprises at least one of silver (Ag), copper (Cu), and chrome (Cr).

The bus electrode comprises Ag particles and a black material and the Ag particles are coated with the black material.

The black material is conductive.

When the black material is conductive, the thickness of the black material with which the Ag particles are coated ranges from 0.1 μm to 5 μm.

The black material is non-conductive.

When the black material is non-conductive, the thickness of the black material with which the Ag particles are coated ranges from 0.1 μm to 1 μm.

Hereinafter, a PDP according to a first embodiment of the present invention will be described with reference to the attached drawings.

### First Embodiment

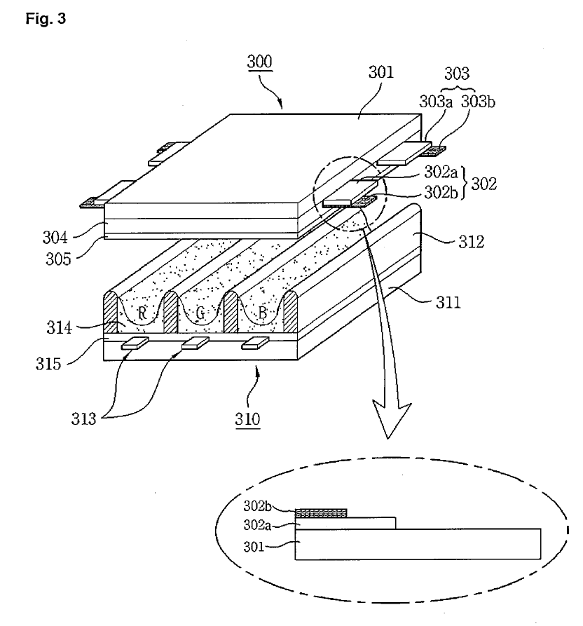

FIG. 3 illustrates the structure of the PDP according to the first embodiment of the present invention.

Referring to FIG. 3, in the PDP according to the first embodiment of the present invention, a front panel 300 obtained by arranging a plurality of pairs of sustain electrodes formed of scan electrodes 302 and sustain electrodes 303 that make pairs and a rear panel 310 obtained by arranging a plurality of address electrodes 313 to intersect the plurality of pairs of sustain electrodes are combined with each other to run parallel to each other by a uniform distance.

In the front panel 300, the scan electrode 302 and the sustain electrode 303 for discharging each other in one discharge cell to sustain emission of the cell are formed on a front glass 301. The scan electrode 302 and the sustain electrode 303 comprise transparent electrodes 302a and 303a made of a transparent material and bus electrodes 302b and 303b comprising a black material.

The transparent electrodes 302a and 303a are made of indium tin oxide (ITO) of indium oxide and tin oxide. The bus electrodes 302b and 303b mainly comprise silver (Ag) and may comprise one of copper (Cu) and chrome (Cr). Also, the bus electrodes 302b and 303b may comprise a mixture obtained by mixing two or more of Ag, Cu, and Cr with each other. The scan electrodes 302 and the sustain electrodes 303 are covered with an upper dielectric layer 304 for restricting discharge current and for insulating electrode pairs from each other. A protective layer 305 on which magnesium oxide (MgO) is deposited is formed on the entire surface of the upper dielectric layer 304 in order to facilitate discharge.

In the rear panel 310, the address electrodes 313 are formed on a rear glass 311 so that data can be written by writing discharge generated between the scan electrode 302 and the address electrodes 313. Also, the address electrodes 313 are covered with a lower dielectric layer 315 so that discharge current is restricted. Stripe type barrier ribs 312 for forming a plurality of discharge cells are arranged on the lower dielectric layer 315 to run parallel to each other. Also, R, G, and B phosphors 314 that emit visible rays for displaying an image during discharge are filled between the lower dielectric layer 315 and the barrier ribs 312.

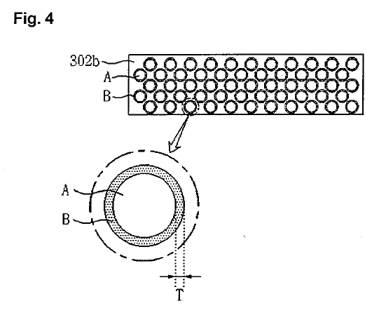

In the PDP according to the first embodiment of the present invention having the above-described structure, the material of the bus electrodes is changed without a black layer for improving contrast so that it is possible to sustain contrast. Therefore, it is possible to reduce the manufacturing cost of the PDP. The structure of the bus electrode according to the present invention will be described in detail with reference to FIG. 4.

FIG. 4 illustrates the internal structure of the bus electrode of the PDP according to the first embodiment of the present invention.

Referring to FIG. 4, the bus electrode 302b comprises Ag particles A and a black material B and the surfaces of the Ag particles are coated with the black material B to form the black layer. Here, the bus electrodes are made of the Ag particles, however, may be made of Cu or Cr of high conductivity. The black material layer B with which the surfaces of the Ag particles are coated may be conductive or non-conductive.

The thickness of the conductive black material layer may be equal to or larger than the thickness of the non-conductive black material layer. That is, the thickness of the conductive black material layer preferably ranges from 0.1 μm to 5 μm. This is because it is difficult to prevent light from being reflected to the outside so that contrast may deteriorate when the PDP is driven when the thickness of the black material layer is smaller than 0.1 μm and because electrical conductivity may deteriorate to deteriorate driving efficiency when the thickness of the black material layer is larger than 5 μm.

The thickness of the non-conductive black material layer preferably ranges from 0.1 μm to 1 μm. This is because it is difficult to prevent light from being reflected to the outside so that contrast may deteriorate when the PDP is driven when the thickness of the black material layer is smaller than 0.1 μm and because electrical conductivity may deteriorate to deteriorate driving efficiency due to the non-conductive black material when the thickness of the black material layer is larger than 1 μm.

On the other hand, when the surfaces of the Ag particles are coated with the black material, the electrical conductivity of the black bus electrodes may be lower than the electrical conductivity of the bus electrodes made of Ag due to the black material of low electrical conductivity. However, when the Ag particles coated with the black material are heated, Ag elements are diffused into the black material so that the electrical conductivity of the black bus electrodes increases.

In consideration of the above, since heat of a predetermined temperature is applied to the Ag particles coated with the black material during processes of manufacturing the PDP in which annealing is inevitably performed, although the black material is non-conductive, the bus electrodes sustain electrical conductivity.

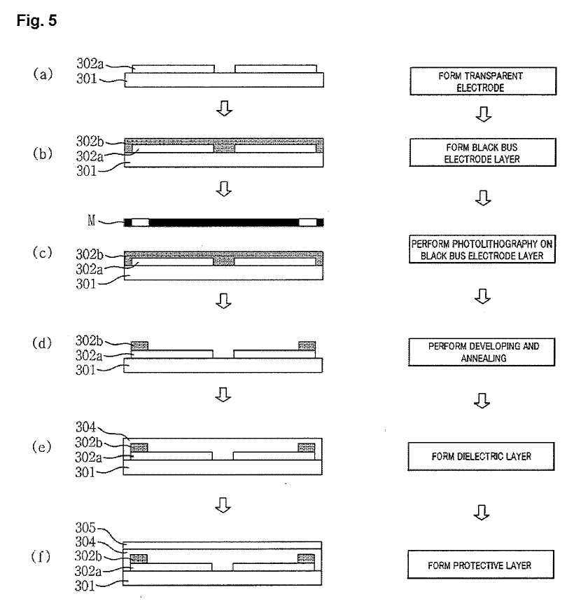

FIG. 5 sequentially illustrates a method of manufacturing a front panel during processes of manufacturing the PDP according to the first embodiment of the present invention.

Referring to FIG. 5, first, in the step (a), the transparent electrode 302a of indium tin oxide (ITO) made of indium oxide and tin oxide is formed on the front glass 301.

Dry film photo resist (DFR) is laminated on a transparent electrode layer made of ITO and photolithography is performed using a photo mask provided with a predetermined pattern and then, developing and etching processes are performed to obtain the transparent electrode 302a.

Then, in the step (b), black bus electrode paste 302b comprising the black material is printed onto the front glass 301 where the transparent electrode 302a is formed and is dried. The black bus electrode paste is a conductive material whose particles are coated with the black material. Since it was described with reference to the structure of the PDP according to the first embodiment of the present invention, description thereof will be omitted.

Then, in the step (c), a photo mask M provided with a predetermined pattern is put on the dried black bus electrode paste and is irradiated with UV rays to be dried. Such a process is referred to as photolithography.

After performing the photolithography process, in the step (d), the part that is not hardened of the black bus electrode paste 302b is developed and is annealed in an annealing furnace (not shown) to form the black bus electrode layer 302b. In the annealing process, Ag is diffused into the black material with which the surfaces of the Ag particles are coated so that, although the black material is non-conductive, the black material has conductivity. Therefore, the electrical conductivity of the black bus electrode is sufficiently sustained.

Then, in the step (e), the dielectric layer 304 is formed on the front glass where the black bus electrode layer is formed. Dielectric glass paste is applied and is dried and then, annealing is performed at the temperature that ranges from 500° C. to 600° C. to form the dielectric layer 304.

Finally, in the step (f), the protective layer 305 made of MgO is formed on the surface of the dielectric layer 304 by a chemical vapor deposition (CVD) method, an ion plating method, or a vacuum deposition method to complete the front panel of the PDP.

The surface of the conductive material such as Ag that forms the bus electrode is coated with the black material to form the black bus electrode so that it is possible to prevent the align error from being generated between the black layer and the bus electrode layer.

Also, contrast is sustained although the process of forming the black layer of the PDP is omitted during the processes of manufacturing the front panel so that it is possible to reduce the manufacturing time of the PDP, to improve production yield, and to reduce manufacturing cost.

A PDP according to a second embodiment of the present invention comprises a front panel in which bus electrodes comprising a black material are formed on a substrate and a rear panel attached to the front panel to be separated from each other by a predetermined distance.

The bus electrodes comprise at least one of Ag, Cu, and Cr.

The bus electrodes comprise Ag particles and the black material and the Ag particles are coated with the black material.

The black material is conductive.

The thickness of the black material ranges from 0.1 μm to 5 μm.

The black material is non-conductive.

The thickness of the black material ranges from 0.1 μm to 1 μm.

### Second Embodiment

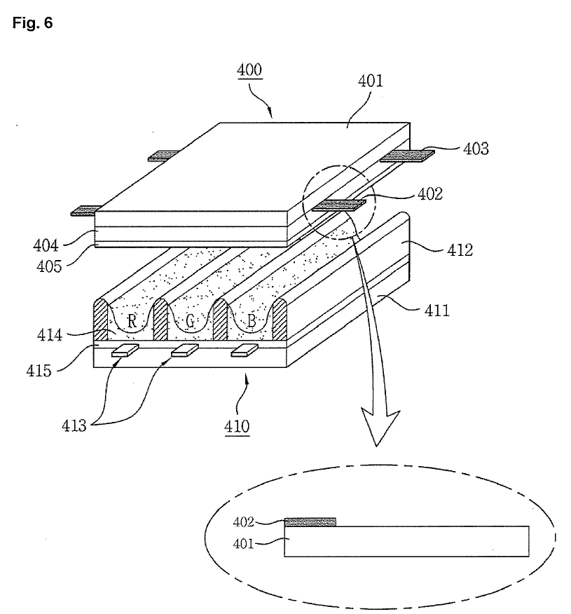

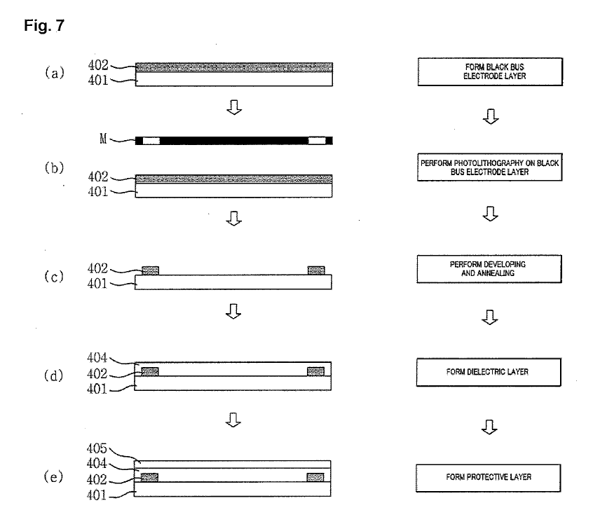

FIG. 6 illustrates the structure of the PDP according to the second embodiment of the present invention.

Referring to FIG. 6, the structure of the PDP according to the second embodiment of the present invention is almost the same as the structure of the PDP according to the first embodiment of the present invention. Therefore, description of the same structure as the structure of the PDP according to the first embodiment of the present invention will be omitted. In the PDP according to the second embodiment of the present invention, a scan electrode 402 and a sustain electrode 403 do not comprise transparent electrodes but comprise only bus electrodes 402b and 403b.

The PDP according to the second embodiment of the present invention having the above structure has the effects of the PDP according to the first embodiment of the present invention. Furthermore, the transparent electrodes are omitted so that it is possible to reduce the manufacturing cost.

FIG. 7 sequentially illustrates a method of manufacturing a front panel during the processes of manufacturing the PDP according to the second embodiment of the present invention.

Referring to FIG. 7, the method of manufacturing the front panel of the PDP according to the second embodiment of the present invention is almost the same as the method of manufacturing the front panel of the PDP according to the first embodiment of the present invention. During the manufacturing of the front panel, unlike in the first embodiment, the process of forming the transparent electrodes is omitted and the black bus electrode 402 is directly formed on a substrate 401 made of glass.

In the method of manufacturing the PDP according to the second embodiment of the present invention, it is possible to reduce the number of manufacturing processes of the PDP and to thus improve the production yield.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

1. A plasma display panel comprising:
a front panel comprising a bus electrode comprising a black material formed on a transparent electrode; and
a rear panel attached to the front panel with a predetermined distance therebetween.

2. The plasma display panel of claim 1, wherein the bus electrode comprises at least one of silver(Ag), copper(Cu) or chrome(Cr).

3. The plasma display panel of claim 1,
wherein the bus electrode comprises a silver particle and the black material;
wherein the black material coats the silver particle.

4. The plasma display panel of claim 1,
wherein the black material comprises a conductive material.

5. The plasma display panel of claim 3, wherein the black material comprises a conductive material.

6. The plasma display panel of claim 5, wherein the thickness of the black material ranges from 0.1 μm to 5 μm.

7. The plasma display panel of claim 1, wherein the black material comprises a non-conductive material.

8. The plasma display panel of claim 3, wherein the black material comprises a non-conductive material.

9. The plasma display panel of claim 8, wherein the thickness of the black material ranges from 0.1 μm to 1 μm.

10. A plasma display panel comprising:
a front panel comprising a bus electrode comprising a black material formed on a substrate; and
a rear panel attached to the front panel with a predetermined distance therebetween.

11. The plasma display panel of claim 10, wherein the bus electrode comprises at least one of silver(Ag), copper(Cu) or chrome(Cr).

12. The plasma display panel of claim 10,
wherein the bus electrode comprises a silver particle and a black material; and
wherein the black material coats the silver particle.

13. The plasma display panel of claim 10,
wherein the black material comprises a conductive material.

14. The plasma display panel of claim 12, wherein the black material comprises a conductive material.

15. The plasma display panel of claim 14, wherein the thickness of black material ranges from 0.1 μm to 5 μm.

16. The plasma display panel of claim 10, wherein the black material comprises a non-conductive material.

17. The plasma display panel of claim 12, wherein the black material comprises a non-conductive material.

18. The plasma display panel of claim 17, wherein the thickness of black material ranges from 0.1 μm to 1 μm.

19. A method of manufacturing a plasma display panel comprising:
(a) forming a transparent electrode on a substrate;
(b) depositing on the transparent electrode a bus electrode paste comprising a black material and either a silver(Ag) particle or a copper(Cu) particle; and
(c) forming a bus electrode pattern by exposing the bus electrode paste.

20. The method of claim 19,
wherein the black material coats the silver particle or the copper particle.
